(19) United States
(12) Patent Application Publication
(10) Pub. No.: US 2023/0169584 A1
(43) Pub. Date: Jun. 1, 2023

(54) SYSTEMS AND METHODS FOR PROVIDING STRUCTURE MANAGEMENT

(71) Applicant: JPMORGAN CHASE BANK, N.A., New York, NY (US)

(72) Inventors: Naveen MALLELA, Singapore (SG); Lawrence Charles DRAKE, Bournemouth (GB); Michael BELLAMY, Verwood (GB)

(21) Appl. No.: 18/073,440

(22) Filed: Dec. 1, 2022

Related U.S. Application Data
(60) Provisional application No. 63/264,736, filed on Dec. 1, 2021.

(51) Int. Cl. G06Q 40/02

(52) U.S. Cl. CPC G06Q 40/02

(57) ABSTRACT

A method for structure management may include a structure management computer program: (1) establishing a structure for a plurality of elements within an organization, each element associated with a summary account, wherein the structure identifies a hierarchical relationship among the plurality of summary accounts and a plurality of activity accounts; (2) receiving, from a user interface for a user, a query comprising a query element; (3) identifying one of the plurality of summary accounts in the structure that matches the query element; (4) retrieving an identification of a subset of the activity accounts that are associated with the identified summary account from the structure; (5) querying a distributed ledger for activity account data for the subset of the activity accounts; and (6) returning the activity account data to the user interface.

### RELATED APPLICATIONS

This application claims priority to, and the benefit of, U.S. Provisional Pat. Application Ser. No. 63/264,736, filed Dec. 1, 2021, the disclosure of which is hereby incorporated, by reference, in its entirety.

### BACKGROUND OF THE INVENTION

### 1. Field of the Invention

Embodiments are generally directed to systems and methods for providing structure management.

### 2. Description of the Related Art

Relationships between entities, accounts, etc. may be fixed. For example, there may be a hierarchical structure in place that cannot be modified. While collecting data from a group of entities that has such relationships is fairly easy, it is difficult to group data from unrelated entities without having to generate an entirely new relationship structure.

### SUMMARY OF THE INVENTION

Systems and methods for providing structure management are disclosed. In one embodiment, a method for structure management may include: (1) establishing, by a structure management computer program, a structure for a plurality of elements within an organization, each element associated with a summary account, wherein the structure identifies a hierarchical relationship among the plurality of summary accounts and a plurality of activity accounts; (2) receiving, by the structure management computer program and from a user interface for a user, a query comprising a query element; (3) identifying, by the structure management computer program, one of the plurality of summary accounts in the structure that matches the query element; (4) retrieving, by the structure management computer program, an identification of a subset of the activity accounts that are associated with the identified summary account from the structure; (5) querying, by the structure management computer program, a distributed ledger for activity account data for the subset of the activity accounts; and (6) returning, by the structure management computer program, the activity account data to the user interface.

In one embodiment, each of the plurality of elements comprises a business, an asset, a worker, a subcontractor, or a machine.

In one embodiment, each of the activity accounts comprises a financial account.

In one embodiment, the activity data comprises transaction data.

In one embodiment, the identified summary account comprises a second summary account that is lower than the identified summary account in the hierarchy.

In one embodiment, the distributed ledger enforces entitlements for the user before retrieving the activity data.

According to another embodiment, a system may include a structure database comprising a structure for a plurality of elements within an organization, each element associated with a summary account, wherein the structure identifies a hierarchical relationship among the plurality of summary accounts and a plurality of activity accounts; a distributed ledger network comprising activity account data for the plurality of activity accounts; and a structure management computer program executed by an electronic device that establishes the structure in the structure database, receives a query comprising a query element from a user interface, identifies one of the plurality of summary accounts in the structure that matches the query element, retrieves an identification of a subset of the activity accounts that are associated with the identified summary account from the structure, queries the distributed ledger for activity account data for the subset of the activity accounts, and returns the activity account data to the user interface.

In one embodiment, each of the plurality of elements comprises a business, an asset, a worker, a subcontractor, or a machine.

In one embodiment, each of the activity accounts comprises a financial account.

In one embodiment, the activity data comprises transaction data.

In one embodiment, the identified summary account comprises a second summary account that is lower than the identified summary account in the hierarchy.

In one embodiment, the distributed ledger enforces entitlements for the user before retrieving the activity data.

According to another embodiment, a non-transitory computer readable storage medium may include instructions stored thereon, which when read and executed by one or more computer processors, cause the one or more computer processors to perform steps comprising: establishing a structure for a plurality of elements within an organization, each element associated with a summary account, wherein the structure identifies a hierarchical relationship among the plurality of summary accounts and a plurality of activity accounts; receiving, from a user interface for a user, a query comprising a query element; identifying one of the plurality of summary accounts in the structure that matches the query element; retrieving an identification of a subset of the activity accounts that are associated with the identified summary account from the structure; querying a distributed ledger for activity account data for the subset of the activity accounts; and returning the activity account data to the user interface.

In one embodiment, each of the plurality of elements comprises a business, an asset, a worker, a subcontractor, or a machine.

In one embodiment, each of the activity accounts comprises a financial account.

In one embodiment, the activity data comprises transaction data.

In one embodiment, the identified summary account comprises a second summary account that is lower than the identified summary account in the hierarchy.

In one embodiment, the distributed ledger enforces entitlements for the user before retrieving the activity data.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for providing structure management according to an embodiment;

FIG. 2 depicts a method for providing structure management according to an embodiment;

FIG. 3 depicts an example of a computing system for implementing certain aspects of the present disclosure; and

FIG. 4 depicts an exemplary computing system for implementing aspects of the present disclosure.

### DETAILED DESCRIPTION OF PREFERRED EMBODIMENTS

Embodiments are directed to systems and methods for providing structure management.

Embodiments may allow users, such as operations teams, to create structure agreements that create and maintain account structures, such as blockchain account structure, virtual account structures, e-wallet structures, etc. similar to, and inclusive of, information required for traditional physical bank accounts. Embodiments may create and manage different types of accounts, such as virtual accounts, e-wallet accounts, etc., and may manage these accounts through a common service.

Embodiments may create and maintain a blockchain account structure.

In embodiments, a structure management service, or SMS, may be available all the time (i.e., 24 hours a day, 7 days a week), may be scalable (e.g., to hundreds of millions of nodes), may provide real-time updates, may provide immediate availability to funds, may provide event notification, auditing, and monitoring of actions and flows, may support multiple client accounts structures, etc.

Embodiments may allow for customer onboarding to a distributed ledger (e.g., a blockchain) account and for setting up and managing the distributed ledger account structure. Examples of fields in the account structure may include a branch, a customer, a currency type, and product information. Embodiments facilitate the migration of traditional bank account structures to the distributed ledger with any requisite attributes.

The creation of the distributed ledger account may include a maker and checker process, and the account may only be created if certain criteria are met. For example, the processes may maintain parameters needed to support products at the client, account, or any other level. The process may enable account agreements to be fulfilled such as pricing, taxes, etc., which may be processed according to the account type.

Account closure may also go through another maker and checker flow, ensuring that there are no future non-zero balances or pending booked activities. Account modifications, such as opening, updates, closures, etc. may generate events that are posted to a messaging queue, to an endpoint linked to other microservices, etc.

Although embodiments may be described in the context of financial accounts, it should be recognized that the disclosure may be applied to any entities or accounts that may have a relationship structure, such as a hieratical structure, including business entities, assets, subcontractors, employees, etc.

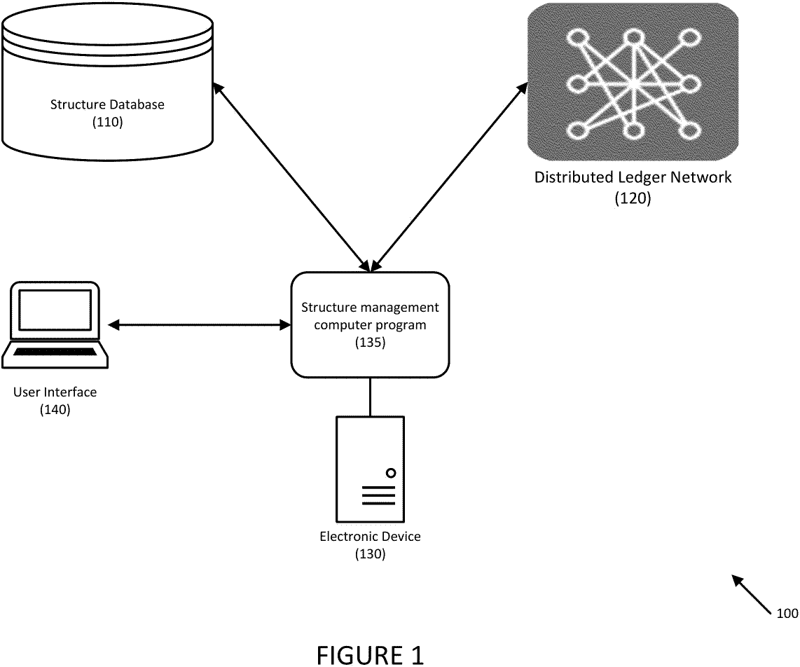

Referring to FIG. 1, a system for providing structure management is disclosed. System 100 may include structure database 110, distributed ledger network 120, electronic device 130 executing structure management computer program 135, and user interface 140. Structure database 110 may be any suitable data repository that maintains a configurable structure for a plurality of elements, such as entities, businesses, assets, workers, subcontractors, machines, devices, accounts, etc. For example, structure database 110 may be a relational database, a graph database, etc. that identifies a plurality of entities as well as the relationships between those entities.

Structure database 110 may also identify activity accounts and identify the association between the activity accounts and one or more elements. Activity accounts may identify activities, balances, transactions, etc. with an account.

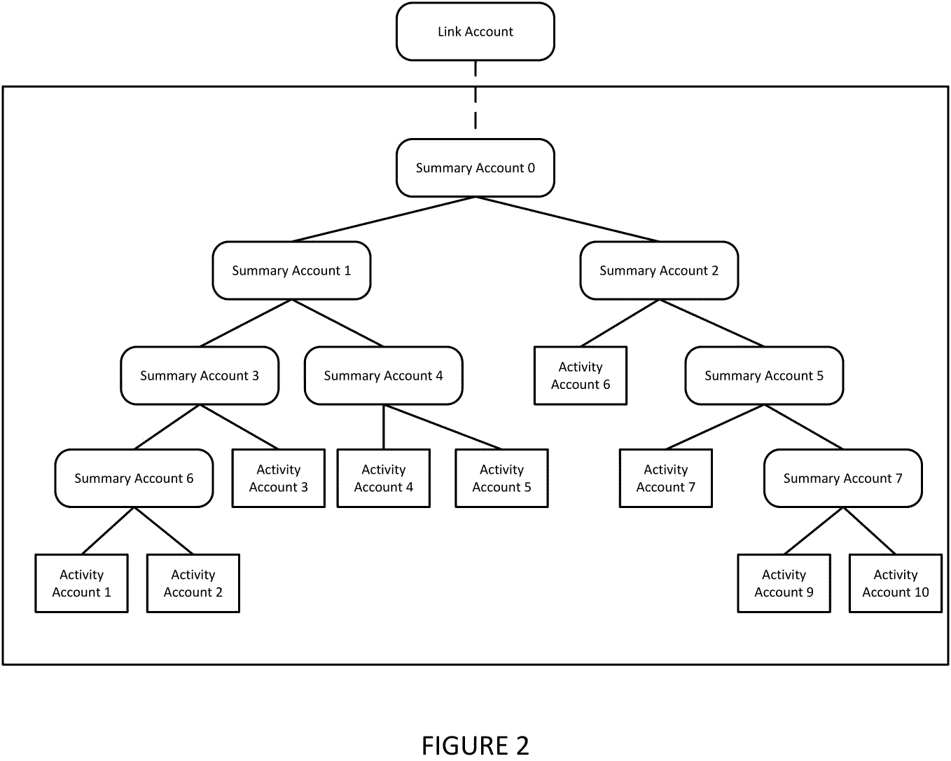

An example of a structure is provided in FIG. 2. FIG. 2 depicts a plurality of summary accounts (e.g., summary account 0, summary account 1, ... summary account 7) and a plurality of activity accounts (e.g., activity account 1, activity account 2, ... activity account 10). Each summary account may be associated with one or more elements, and each activity account may represent activity with one of the summary accounts. Structure database 110 may allow the relationships between summary accounts and between summary accounts and activity accounts to be dynamic. For example, activity account 6 may be moved from summary account 2 to summary account 1 without requiring any of the activity data in activity account 6 to be modified or changed.

Distributed ledger network 120 may maintain activity data associated with the entities maintained in structure database 110. Examples of activity data may include position data, transaction data, balance data, etc.

In one embodiment, non-distributed ledger networks may be used as is necessary and/or desired.

Thus, the structure and the underlying activity data are maintained separately.

Electronic device 130 may be any suitable electronic device, including servers (physical and/or cloud-based), computers (e.g., workstations, desktops, laptops, notebooks, tablets, etc.), smart devices, Internet of Things (IoT) appliances, etc. Structure management computer program 135 may interface with structure database 110 and distributed ledger network 120, and may combine activity data from both as is necessary and/or desired.

For example, structure management computer program 135 may receive an inquiry from user interface 140 for activity data for a grouping of entities. Structure management computer program 135 may query structure database 110 for a structure and may then retrieve activity data for entities within the structure from distributed ledger network 120. It may then output the activity data to user interface 140.

Illustratively, structure management computer program 135 may receive a request for activities involving summary account 3. Structure management computer program may query structure database 110 for the activity accounts falling under summary account 3, returning activity account 1, activity account 2, and activity account 3. Structure management computer program may then access distributed ledger 120 to retrieve the requested activity data for summary accounts 1, 2, and 3, and may then return the activity data to user interface 140.

In another example, structure management computer program 135 may receive a request for information about an activity account, such as activity account 1. Structure management computer program 135 may retrieve the hierarchy of summary accounts that are associated with activity account 1 (e.g., summary account 6, summary account 3, summary account 1, and summary account 0) and may return that to user interface 140.

As another example, structure management computer program 135 may receive a selection of a group of a plurality of nodes for retrieval, such as activity account 3, activity account 6, activity account 9, and summary account 6. Structure management computer program 135 may retrieve the structure from structure database 110 (e.g., activity account 3, activity account 6, activity account 9, activity account 1, and activity account 2), and may then retrieve the requested activity data for these activity accounts from distributed ledger 120. It may then return the retrieved activity data to user interface 140.

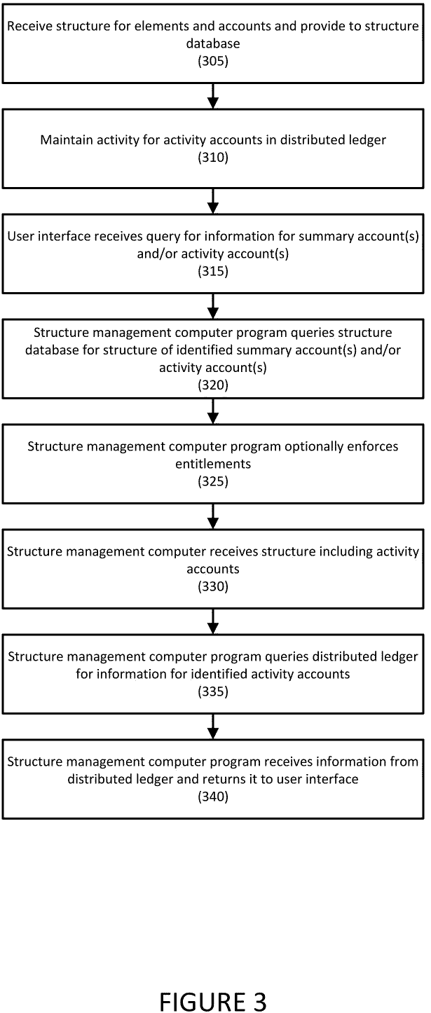

Referring to FIG. 3, a method for providing structure management is disclosed according to an embodiment.

In step 305, a structure for a plurality of elements, such as entities, businesses, assets, workers, subcontractors, machines, devices, accounts, etc. may be established. Each element may be associated with a summary account. In one embodiment, a user may set up a structure into a structure database. The structure database may be a graph database that may identify relationships between the elements.

In addition, the structure database may also identify activity accounts and identify the association between the activity accounts and one or more elements.

In one embodiment, the activity accounts in the structure database may include a pointer to a location on the distributed ledger where account information (e.g., transactions, activities, balances, etc.) may be located.

In step 310, activity data for the activity accounts may be maintained in a distributed ledger, such as a blockchain-based ledger. The activity data may be received from any participating entity in the distributed ledger network.

In step 315, using a user interface, a user may submit a query for information regarding activity accounts, a hierarchy, etc. For example, the user may identify one or more summary accounts, one or more activity accounts, or a combination of both (e.g., a grouping) to the user interface. The user may also identify the information to be retrieved (e.g., activity, balances, relationships, etc.).

In step 320, a structure management computer program may query the structure database with the summary account(s), activity account(s), or combination that were received from the user interface.

In step 325, the structure management computer program may optionally enforce entitlements in the retrieval process. For example, if a user is not authorized to retrieve certain activity data for an element, or a certain type of activity data, the structure management computer program will not retrieve the activity data. For example, a user may be entitled to access all activity data for summary accounts and activity accounts below it in the hierarchy, but may not be able to access activity data above it in the hierarchy.

In one embodiment, entitlements may be enforced by the distributed ledger network, wherein a user’s entitlements to retrieve the activity data may be verified before the actual activity data is retrieved.

In step 330, the structure management computer program may receive the structure, such as the activity accounts, associated with the summary accounts.

In step 335, the structure management computer program may query a distributed ledger that may maintain activity account activity for the identified activity accounts. In one embodiment, the structure management computer program may identify the type of activity data to retrieve (e.g., activities, balances, transactions, etc.) for the identified activity accounts.

In step 340, the structure management computer program may return the activity account information to the user interface. In one embodiment, the structure management computer program may combine the activity information before presenting it to the user interface.

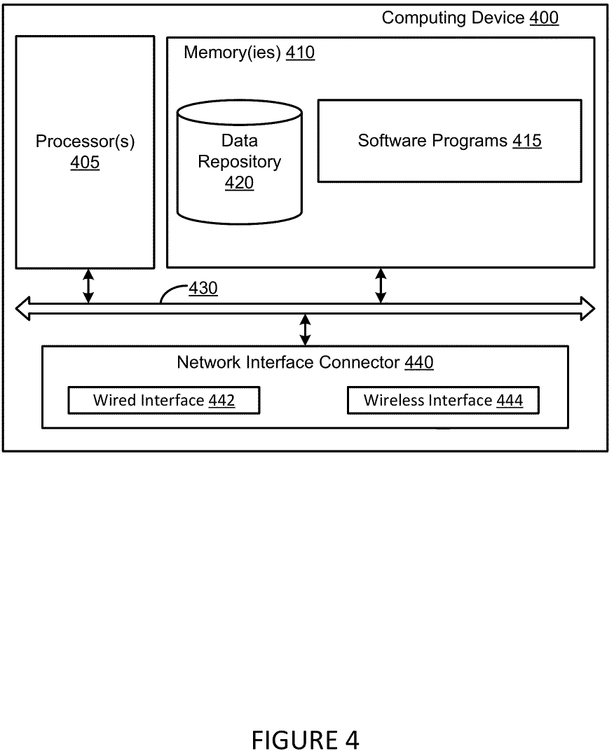

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for structure management, comprising:
establishing, by a structure management computer program, a structure for a plurality of elements within an organization, each element associated with a summary account, wherein the structure identifies a hierarchical relationship among the plurality of summary accounts and a plurality of activity accounts;
receiving, by the structure management computer program and from a user interface for a user, a query comprising a query element;
identifying, by the structure management computer program, one of the plurality of summary accounts in the structure that matches the query element;
retrieving, by the structure management computer program, an identification of a subset of the activity accounts that are associated with the identified summary account from the structure;
querying, by the structure management computer program, a distributed ledger for activity account data for the subset of the activity accounts; and
returning, by the structure management computer program, the activity account data to the user interface.

2. The method of claim 1, wherein each of the plurality of elements comprises a business, an asset, a worker, a subcontractor, or a machine.

3. The method of claim 1, wherein each of the activity accounts comprises a financial account.

4. The method of claim 1, wherein the activity data comprises transaction data.

5. The method of claim 1, wherein the identified summary account comprises a second summary account that is lower than the identified summary account in the hierarchy.

6. The method of claim 1, wherein the distributed ledger enforces entitlements for the user before retrieving the activity data.

7. A system, comprising:
a structure database comprising a structure for a plurality of elements within an organization, each element associated with a summary account, wherein the structure identifies a hierarchical relationship among the plurality of summary accounts and a plurality of activity accounts;
a distributed ledger network comprising activity account data for the plurality of activity accounts; and
a structure management computer program executed by an electronic device that establishes the structure in the structure database, receives a query comprising a query element from a user interface, identifies one of the plurality of summary accounts in the structure that matches the query element, retrieves an identification of a subset of the activity accounts that are associated with the identified summary account from the structure, queries the distributed ledger for activity account data for the subset of the activity accounts, and returns the activity account data to the user interface.

8. The system of claim 7, wherein each of the plurality of elements comprises a business, an asset, a worker, a subcontractor, or a machine.

9. The system of claim 7, wherein each of the activity accounts comprises a financial account.

10. The system of claim 7, wherein the activity data comprises transaction data.

11. The system of claim 7, wherein the identified summary account comprises a second summary account that is lower than the identified summary account in the hierarchy.

12. The system of claim 7, wherein the distributed ledger enforces entitlements for the user before retrieving the activity data.

13. A non-transitory computer readable storage medium, including instructions stored thereon, which when read and executed by one or more computer processors, cause the one or more computer processors to perform steps comprising:
establishing a structure for a plurality of elements within an organization, each element associated with a summary account, wherein the structure identifies a hierarchical relationship among the plurality of summary accounts and a plurality of activity accounts;
receiving, from a user interface for a user, a query comprising a query element;
identifying one of the plurality of summary accounts in the structure that matches the query element;
retrieving an identification of a subset of the activity accounts that are associated with the identified summary account from the structure;
querying a distributed ledger for activity account data for the subset of the activity accounts; and
returning the activity account data to the user interface.

14. The non-transitory computer readable storage medium of claim 13, wherein each of the plurality of elements comprises a business, an asset, a worker, a subcontractor, or a machine.

15. The non-transitory computer readable storage medium of claim 13, wherein each of the activity accounts comprises a financial account.

16. The non-transitory computer readable storage medium of claim 13, wherein the activity data comprises transaction data.

17. The non-transitory computer readable storage medium of claim 13, wherein the identified summary account comprises a second summary account that is lower than the identified summary account in the hierarchy.

18. The non-transitory computer readable storage medium of claim 13, wherein the distributed ledger enforces entitlements for the user before retrieving the activity data.
